(19) United States
(12) Patent Application Publication
(10) Pub. No.: US 2025/0132582 A1
(43) Pub. Date: Apr. 24, 2025

(54) DEAD TIME DETERMINATION METHOD, CHARGING DRIVING CIRCUIT AND APPARATUS, AND DEVICE AND MEDIUM

(71) Applicant: Changchun Jetty Automotive Technology Co., Ltd., Changchun, Jilin (CN)

(72) Inventors: Chao Wang, Jilin (CN); Guoqing CAO, Jilin (CN)

(21) Appl. No.: 18/686,774

(22) PCT Filed: Aug. 22, 2022
(86) PCT No.: PCT/CN2022/113854

§ 371 Date: Feb. 26, 2024

(30) Foreign Application Priority Data
Aug. 26, 2021 (CN) 202110988747.2

(51) Int. Cl. H02J 7/00; B60L 53/62

(52) U.S. Cl. CPC H02J 7/0047; H02J 7/00712; B60L 53/62

(57) ABSTRACT

Disclosed by the present disclosure are a dead time determination method, a charging driving circuit and apparatus, and a device and a medium. The dead time determination method includes: acquiring output current of a charging driving circuit; determining a load status of the charging driving circuit according to the output current of the charging driving circuit; acquiring an output voltage of the charging driving circuit; and determining dead time of the charging driving circuit according to the output voltage and the load status of the charging driving circuit. According to the present disclosure, the dead time of the charging driving circuit in different load statuses can be determined according to the output current and output voltage of the charging driving circuit, so that enables the charging apparatus to output stable voltage or current.

### RELATED APPLICATION

The present disclosure claims the priority of the Chinese patent application with an application number of 202110988747.2, an invention title of ‘dead time determination method, charging driving circuit, apparatus, device and medium’, and filed on Aug. 26, 2021, the entire content of which is incorporated herein by reference.

### TECHNICAL FIELD

The present disclosure relates to the field of electric power, and particularly to a dead time determination method, a charging driving circuit, an apparatus, a device and a medium.

### BACKGROUND

This section is intended to provide a background or context for the embodiments of the present disclosure set forth in the claims. The description here is not admitted to be the prior art although it is included in this section.

With the development of new energy automobiles, it is a new market demand to charge the new energy automobiles quickly. The existing charging piles often need a long charging duration to charge electric automobiles. In order to improve the charging efficiency of a power source, a power component in a bridge circuit should work in a soft switching state, so it is necessary to reasonably adjust the dead time corresponding to the power component.

In the related art, fixed time control is usually adopted to control the dead time of the power component. However, when the dead time is controlled in this way in the related art, the dead time in some working areas may be shorter than actual soft switching time, which leads to insufficient soft switching and reduces the charging efficiency of the power source.

### SUMMARY

The embodiments of the present disclosure provide a dead time determination method for determining dead time of a charging driving circuit in real time, including: acquiring output current of a charging driving circuit; determining a load status of the charging driving circuit according to the output current of the charging driving circuit; acquiring an output voltage of the charging driving circuit; and determining dead time of the charging driving circuit according to the output voltage and the load status of the charging driving circuit.

Further, the load status is a no-load status or a loaded status.

Further, determining the dead time y₁ of the charging driving circuit in the no-load status includes: calculating a product of a proportional coefficient k and an input voltage x; and calculating a sum of the product and a bias constant b, as the dead time y₁ of the charging driving circuit in the no-load status.

Further, determining the dead time y of the charging driving circuit in the loaded status includes: calculating a product of a first coefficient and a ratio of a system clock frequency f to a working frequency; calculating a difference between the dead time y₁ of the charging driving circuit in the no-load status and the product; and calculating a product of the difference and a second coefficient, as the dead time y of the charging driving circuit in the loaded status.

Further, determining the load status of the charging driving circuit according to the output current of the charging driving circuit includes: if the output current of the charging driving circuit is greater than a first preset threshold, determining the load status of the charging driving circuit as a loaded status; and if the output current of the charging driving circuit is less than a second preset threshold, determining the load status of the charging driving circuit as a no-load status.

Further, the first preset threshold is greater than the second preset threshold.

The embodiments of the present disclosure further provide a charging driving circuit to solve the technical problem that the power device in the existing charging pile adopts a fixed dead time and requires a long charging time for charging the electric automobile. The charging driving circuit includes: a power source module, a voltage collection module, a current collection module, a transistor driving circuit, a transistor switching circuit and a micro-control unit; in which the power source module is connected to a power source device and configured to provide a power supply voltage; the transistor switching circuit is connected to a load device and configured to supply power to the load device; the transistor driving circuit is connected between the micro-control unit and the transistor switching circuit, and configured to drive the transistor switching circuit to be turned on or off; the voltage collection module is connected to an output end of the transistor switching circuit and configured to collect an output voltage of the transistor switching circuit; the current collection module is connected to the output end of the transistor switching circuit and configured to collect output current of the transistor switching circuit; the micro-control unit is connected to the voltage collection module and the current collection module respectively, in which the micro-control unit is configured to determine dead time of the charging driving circuit according to the output voltage of the transistor switching circuit and the load status of the charging driving circuit, and generate a control signal that controls the transistor switching circuit to be turned on or off according to the dead time.

Further, the transistor driving circuit is implemented by a first drive chip and a second drive chip, each being a dual-channel isolated gate driver with dual input interfaces to drive a half-bridge circuit or a full-bridge circuit.

Further, the chip model used for the first drive chip and the second drive chip is UCC21520.

Further, the micro-control unit includes: an acquisition unit configured to acquire the output voltage and the output current of the charging driving circuit; a judgement unit configured to judge a load status of the charging driving circuit according to the output current; and a calculation unit configured to calculate the dead time of the charging driving circuit according to the output voltage and the load status.

The embodiments of the present disclosure further provide a charging apparatus to solve the technical problem that the power device in the existing charging pile adopts a fixed dead time and requires a long charging time for charging the electric automobile. The charging device includes: the aforementioned charging driving circuit.

The embodiments of the present disclosure further provide a computer device to solve the technical problem that the power device in the existing charging pile adopts a fixed dead time and requires a long charging time for charging the electric automobile. The computer device includes a memory, a processor, and a computer program stored in the memory and executable in the processor, in which when executing the computer program, the processor implements the aforementioned dead time determination method.

The embodiments of the present disclosure further provide a computer-readable storage medium to solve the technical problem that the power device in the existing charging pile adopts a fixed dead time and requires a long charging time for charging the electric automobile. The computer-readable storage medium stores a computer program which performs the aforementioned dead time determination method.

According to the embodiments of the present disclosure, after the output current of the charging driving circuit is collected, the load status of the charging driving circuit is determined according to the output current of the charging driving circuit, and after the output voltage of the charging driving circuit is collected, the dead time of the charging driving circuit is determined according to the output voltage and the load status of the charging driving circuit, so as to obtain the dead time of the charging driving circuit in different load statuses, thereby ensuring sufficient soft switching, and then enabling the charging apparatus to output stable voltage or current.

### BRIEF DESCRIPTION OF THE DRAWINGS

In order to more clearly explain the technical solutions in the embodiments of the present disclosure or in the prior art, the drawings to be used in the description of the embodiments or the prior art will be briefly introduced as follows. Obviously, the drawings concerned in the following description only illustrate some embodiments of the present disclosure, and those of ordinary skill in the art can obtain other drawings from them without paying any creative labor.

FIG. 1 illustrates a schematic diagram of a charging driving circuit according to an embodiment of the present disclosure;

FIG. 2 illustrates a schematic diagram of a MOS driving circuit according to an embodiment of the present disclosure;

FIG. 3 illustrates a flowchart of a dead time determination method according to an embodiment of the present disclosure;

FIG. 4 illustrates a flowchart of a specific implementation of a dead time determination method according to an embodiment of the present disclosure; and

FIG. 5 illustrates a schematic diagram of a computer device according to an embodiment of the present disclosure.

### REFERENCE SIGNS

10: power source module;
20: voltage collection module;
30: current collection module;
40: transistor driving circuit;
50: transistor switching circuit;
60: micro-control unit;
70: computer device;
701: memory;
702: processor.

### DETAILED OF THE EMBODIMENTS

In order that the objectives, technical solutions and advantages of the embodiments of the present disclosure are clearer, the embodiments of the present disclosure will be further described in detail below with reference to the drawings. Here, the exemplary embodiments of the present disclosure and the description thereof are used to explain the present disclosure, rather than limitations thereto.

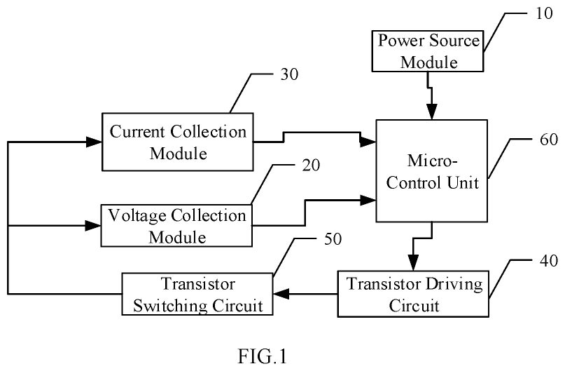

An embodiment of the present disclosure provides a charging driving circuit, and FIG. 1 illustrates a schematic diagram of a charging driving circuit according to an embodiment of the present disclosure. As illustrated in FIG. 1, the charging driving circuit includes a power source module 10, a voltage collection module 20, a current collection module 30, a transistor driving circuit 40, a transistor switching circuit 50 and a micro-control unit 60;
in which the power source module 10 is connected to a power source device and configured to provide a power supply voltage;
the transistor switching circuit 50 is connected to a load device and configured to supply power to the load device;
the transistor driving circuit 40 is connected between the micro-control unit 60 and the transistor switching circuit 50, and configured to drive the transistor switching circuit to be turned on or off;
the voltage collection module 20 is connected to an output end of the transistor switching circuit 50 and configured to collect an output voltage of the transistor switching circuit 50;
the current collection module 30 is connected to the output end of the transistor switching circuit 50 and configured to collect output current of the transistor switching circuit 50; and
the micro-control unit 60 is connected to the voltage collection module 20 and the current collection module 30 respectively, and configured to generate a control signal that controls the transistor switching circuit 50 to be turned on or off according to the output voltage and the output current of the transistor switching circuit 50.

During implementation, the micro-control unit 60 may include an acquisition unit, a judgement unit and a calculation unit, in which the acquisition unit is configured to acquire the output voltage and the output current of the charging driving circuit; the judgement unit is configured to judge a load status of the charging driving circuit according to the output current; and the calculation unit is configured to calculate the dead time of the charging driving circuit according to the output voltage and the load status.

It should be noted that the control signal output by the micro-control unit 60 may be a square wave signal, and high and low levels are output to control the transistor switching circuit to be turned on or off. When the transistor switching circuit is turned on, energy is transferred to a voltage output end, and an output voltage is regulated by controlling the time and speed of turning on the transistor switching circuit so as to output a stable DC voltage.

Since the Metal Oxide Semiconductor Field Effect Transistor (MOSFET) has the advantages of being smaller and more energy-saving, in an embodiment, the transistor according to the embodiments of the present disclosure adopts the MOSFET.

In the charging driving circuit according to the embodiments of the present disclosure, the micro-control unit is implemented by a single chip microcomputer. In an embodiment, the microcontroller may adopt a chip with a model of TMS320F280049CPZS, the main frequency of which is 100 MHZ, which is powerful and has many on-chip analog peripherals.

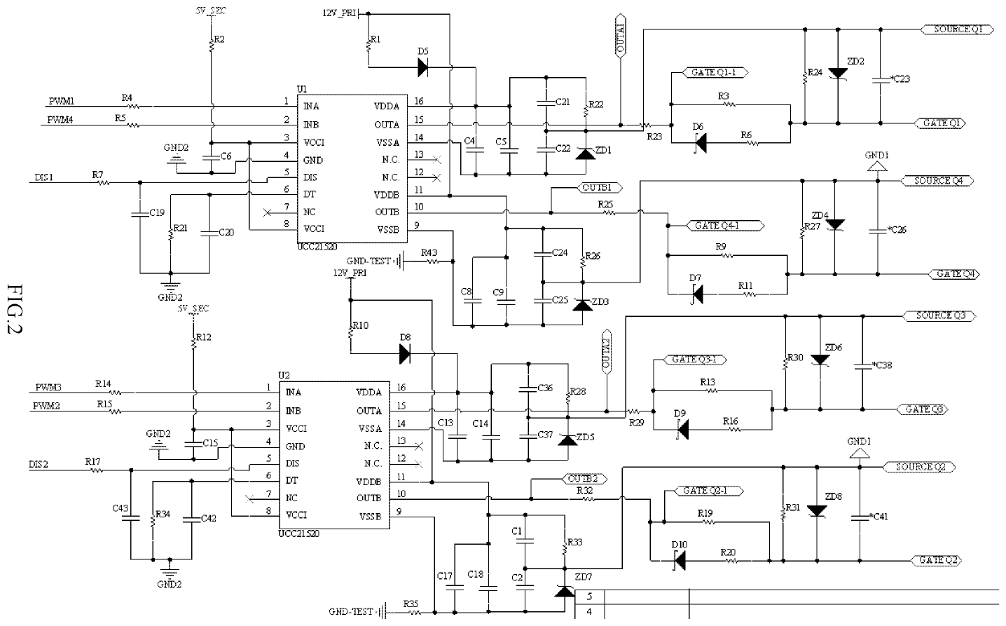

In order to be compatible with a half-bridge circuit and a full-bridge circuit, in an embodiment, in the charging driving circuit according to the embodiments of the present disclosure, the transistor driving circuit is implemented by a first drive chip and a second drive chip, each being a dual-channel isolated gate driver with dual input interfaces to drive the half-bridge circuit or the full-bridge circuit. FIG. 2 illustrates a schematic diagram of a MOS driving circuit according to an embodiment of the present disclosure. U1 and U2 in FIG. 2 represent a first drive chip and a second drive chip, respectively. Herein the chip model used for the first drive chip and the second drive chip is UCC21520.

The UCC21520 is an isolated dual-channel gate driver with 4 A peak source current and 6 A peak sink current. The UCC21520 supports a high switching frequency and has a high isolation strength, and is configured to drive a Metal-Oxide-Semiconductor Field-Effect Transistor (MOSFET), an Insulated Gate Bipolar Transistor (IGBT), etc. Herein, each of the first drive chip and the second drive chip includes a drive part and a control part isolated from each other, and two internal drive channels isolated from each other.

The embodiments of the present disclosure further provide a charging apparatus, which includes any one of the aforementioned charging driving circuits.

It should be noted that the charging apparatus according to the embodiments of the present disclosure may be, but not limited to, a charging apparatus for an electric automobile.

The embodiments of the present disclosure further provide a dead time determination method for determining dead time of a charging driving circuit in real time, and the dead time determination method may be used for, but not limited to, determining the dead time of the aforementioned charging driving circuit.

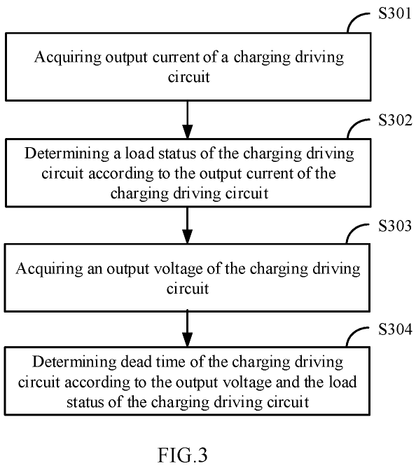

FIG. 3 illustrates a flowchart of a dead time determination method according to an embodiment of the present disclosure. As illustrated in FIG. 3, the method includes:
S301: acquiring output current of a charging driving circuit;
S302: determining a load status of the charging driving circuit according to the output current of the charging driving circuit;
S303: acquiring an output voltage of the charging driving circuit; and
S304: determining dead time of the charging driving circuit according to the output voltage and the load status of the charging driving circuit.

It should be noted that the dead time in the embodiments of the present disclosure is a protection period set to prevent the upper and lower tubes of the full-bridge circuit or the half-bridge circuit from being turned on simultaneously due to the problem of the switching speed. The output current of the charging driving circuit is also the output current of the transistor switching circuit, and the output voltage of the charging driving circuit is also the output voltage of the transistor switching circuit. The load status of the charging driving circuit may be determined according to the output current of the charging driving circuit as follows: if the output current of the charging driving circuit is greater than a first preset threshold, determining the load status of the charging driving circuit as a loaded status; if the output current of the charging driving circuit is less than a second preset threshold, determining the load status of the charging driving circuit as a no-load status, in which the first preset threshold is greater than the second preset threshold, for example, the first preset threshold has a value range of 0.15 A to 0.3 A, and the second preset threshold has a value range of 0.05 A to 0.1 A.

In the embodiments of the present disclosure, the load status includes a no-load status or a loaded status.

In the embodiments of the present disclosure, the no-load status refers to a state in which the charging driving circuit is connected to a load device but not charged; and the loaded status refers to a state in which the charging driving circuit is connected to the load device while being charged.

In an embodiment, the dead time determination method according to the embodiments of the present disclosure may determine the dead time y₁ of the charging driving circuit in the no-load status by the following steps: calculating a first product of a proportional coefficient k and an input voltage x; and calculating a sum of the first product and a bias constant b, as the dead time y₁ of the charging driving circuit in the no-load status. In an embodiment, the dead time of the charging driving circuit in the no-load status is calculated by Formula (1).

$${y}_{1} = kx + b \qquad ( 1 )$$

where y₁ denotes the dead time of the charging driving circuit in the no-load status; k denotes a proportional coefficient representing a time unit; x denotes an input voltage; and b denotes a bias constant.

Further, the dead time determination method according to the embodiments of the present disclosure may determine the dead time y of the charging driving circuit in the loaded status by the following steps: calculating a second product of a first coefficient and a ratio of a system clock frequency f to a working frequency Fsw; calculating a difference between the dead time y₁ of the charging driving circuit in the no-load status and the second product; and calculating a product of the difference and a second coefficient as the dead time y of the charging driving circuit in the loaded status. In an embodiment, the dead time of the charging driving circuit in the loaded status is calculated by Formula (2), in which the first coefficient is equal to 0.3 and the second coefficient is equal to 10.

$$y = ( {y}_{1} - 0.3 \times f / Fsw ) \times 10 \qquad ( 2 )$$

where y denotes the dead time of the charging driving circuit in the loaded status; f denotes a system clock frequency, which has a value range of 0 to 16 KHz; Fsw denotes a working frequency, which has a value range of 50 Hz to 60 Hz.

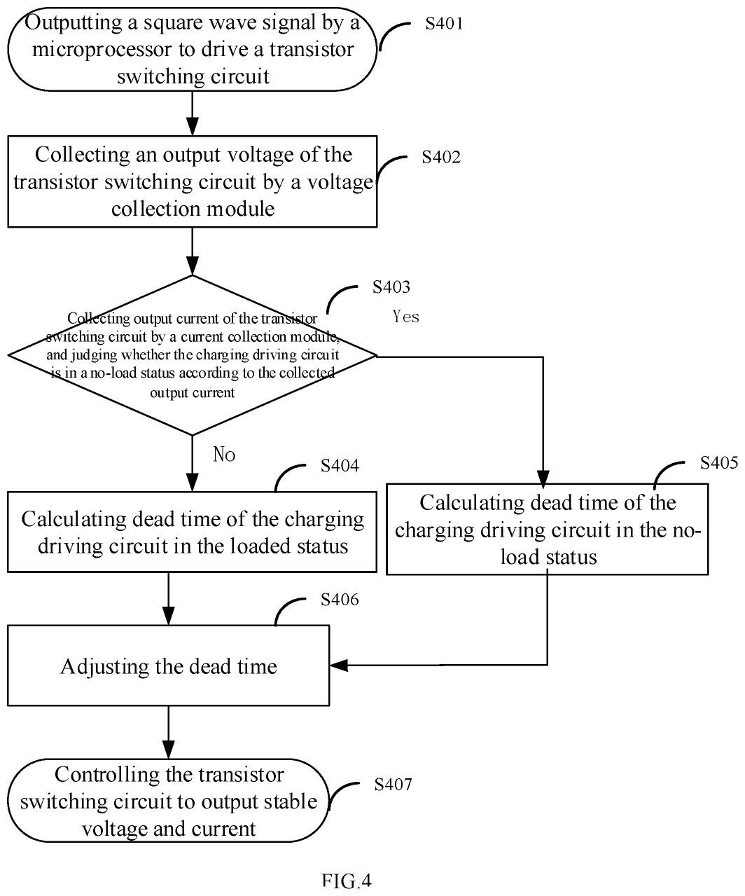

FIG. 4 illustrates a flowchart of a specific implementation of a dead time determination method according to an embodiment of the present disclosure, including:
S401: outputting a square wave signal by a microprocessor to drive a transistor switching circuit;
S402: collecting an output voltage of the transistor switching circuit by a voltage collection module;
S403: collecting output current of the transistor switching circuit by a current collection module, and judging whether the charging driving circuit is in a no-load status according to the collected output current; if not, performing S404; and if so, performing S405;
S404: calculating dead time of the charging driving circuit in the loaded status;
S405: calculating dead time of the charging driving circuit in the no-load status;
S406: adjusting the dead time;
S407: controlling the transistor switching circuit to output stable voltage and current.

It should be noted that when the charging driving circuit is in the no-load status, the dead time varies with the input voltage. The range of the input voltage may be 30 V to 400 V. According to different input voltages, in order to make the charging driving circuit work in the soft switching area, the range of the working frequency of the system is adjusted and determined at first. For example, when the range of the no-load working frequency is 165 K, the range of the dead time is 1900 ns to 400 ns. The dead time of the charging driving circuit in the no-load status may be calculated by the above Formula (1). When the charging driving circuit is in the loaded status, the dead time thereof is calculated by the above Formula (2) according to the dead time y₁ of the charging driving circuit in the no-load status, the working frequency Fsw (the working frequency may be adjusted according to the output voltage using a Proportional Integration Differentiation (PID) adjustment mode) and the system clock frequency f, and then the transistor switching circuit can be controlled to output stable voltage and current according to the dead time of the charging driving circuit in the loaded status.

It should be noted that depending on the output voltage and the output current, the range of the system working frequency of the charging driving circuit according to the embodiments of the present disclosure may be 90K to 165K, and the range of the dead time may be 400 ns to 900 ns.

In order to make the whole system achieve a better working state and a higher efficiency to meet the customer requirements, in one embodiment, the dead time determination method according to the embodiments of the present disclosure may also support the switching between the no-load status and the loaded status.

For example, in a case where the charging driving circuit works in the no-load status, when the output current of the transistor switching circuit is greater than a first preset threshold (e.g., 0.2 A), the transistor switching circuit switches from the no-load status to the loaded status; and in a case where the charging driving circuit works in the loaded status, when the output current of the transistor switching circuit is less than a second preset threshold (e.g., 0.1 A), the transistor switching circuit switches from the loaded status to the no-load status.

Optionally, the load device in the embodiments of the present disclosure is a high-power load device. In a case where the load device is an electric automobile, the charging driving circuit according to the embodiments of the present disclosure may be disposed in a charging pile. The electric automobile can be rapidly and stably charged by disposing the charging driving circuit according to the embodiments of the present disclosure in the charging pile of the electric automobile. The charging driving circuit according to the embodiments of the present disclosure achieves a simple design, an easy replacement of components and a strong market competitiveness. The dead time determination method for the charging driving circuit according to the embodiments of the present disclosure is practical and simple.

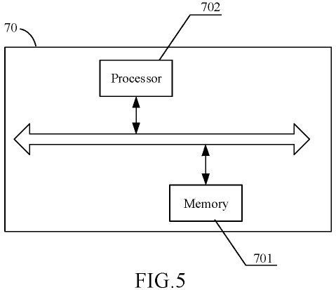

The embodiments of the present disclosure further provide a computer device to solve the technical problem that the power device in the existing charging pile adopts a fixed dead time and requires a long charging time for charging the electric automobile. FIG. 5 illustrates a schematic diagram of a computer device according to an embodiment of the present disclosure. As illustrated in FIG. 5, the computer device 70 includes a memory 701, a processor 702, and a computer program which is stored in the memory 701 and executable in the processor 702, in which when executing the program, the processor 702 implements the aforementioned dead time determination method.

The embodiments of the present disclosure further provide a computer-readable storage medium to solve the technical problem that the power device in the existing charging pile adopts a fixed dead time and requires a long charging time for charging the electric automobile. The computer-readable storage medium stores a computer program which performs the aforementioned dead time determination method.

To sum up, the charging driving circuit, the charging apparatus, the dead time determination method, the computer device and the computer-readable storage medium according to the embodiments of the present disclosure collect the output voltage of the transistor driving circuit by the voltage collection module and collect the output current of the transistor driving circuit by the current collection module, so that the micro-control unit can generate a control signal which controls the transistor switching circuit to be turned on or off according to the output voltage and the output current of the transistor switching circuit, and the transistor switching circuit can output a stable voltage to supply power to the load device. According to the charging driving circuit and the dead time determination method thereof according to the embodiments of the present disclosure, the charging apparatus can output stable voltage or current to the load device.

Those skilled in the art should appreciate that any embodiment of the present disclosure can be provided as a method, a system or a computer program product. Therefore, the present disclosure can take the form of a full hardware embodiment, a full software embodiment, or an embodiment combining software and hardware. Moreover, the present invention can take the form of a computer program product implemented on one or more computer usable storage mediums (including, but not limited to, a magnetic disc memory, CD-ROM, optical storage, etc.) containing therein computer usable program codes.

The present disclosure is described with reference to a flowchart and/or a block diagram of the method, apparatus (system) and computer program product according to the embodiments of the present disclosure. It should be appreciated that each flow and/or block in the flowchart and/or the block diagram and a combination of flows and/or blocks in the flowchart and/or the block diagram can be realized by computer program instructions. Those computer program instructions can be provided to a general computer, a dedicated computer, an embedded processor or a processor of other programmable data processing device to produce a machine, so that the instructions executed by the processor of the computer or other programmable data processing device produce means for realizing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory can produce manufacture articles including an instructing device which realizes function(s) specified in one or more flows in the flowchart and/or one or more blocks in the block diagram.

These computer program instructions may also be loaded onto a computer or any other programmable data processing device, so that a series of operation steps can be performed on the computer or other programmable data processing device to produce a processing realized by the computer, thus the instructions executed on the computer or other programmable device provide step(s) for realizing function(s) specified in one or more flows in the flowchart and/or one or more blocks in the block diagram.

The specific embodiments described above further make detailed explanations to the objectives, technical solutions and advantageous effects of the present disclosure. It should be understood that those described above are only specific embodiments of the present disclosure and are not intended to limit the protection scope of the present disclosure. Any modification, equivalent substitution or improvement made within the spirit and principle of the present disclosure should fall within the protection scope of the present disclosure.

1. A dead time determination method for determining dead time of a charging driving circuit in real time, comprising:
acquiring output current of a charging driving circuit;
determining a load status of the charging driving circuit according to the output current of the charging driving circuit;
acquiring an output voltage of the charging driving circuit; and
determining dead time of the charging driving circuit according to the output voltage and the load status of the charging driving circuit.

2. The dead time determination method according to claim 1, wherein the load status is a no-load status or a loaded status.

3. The dead time determination method according to claim 2, wherein determining the dead time y₁ of the charging driving circuit in the no-load status comprises:
calculating a product of a proportional coefficient k and an input voltage x; and
calculating a sum of the product and a bias constant b, as the dead time y₁ of the charging driving circuit in the no-load status.

4. The dead time determination method according to claim 3, wherein determining the dead time y of the charging driving circuit in the loaded status comprises:
calculating a product of a first coefficient and a ratio of a system clock frequency f to a working frequency;
calculating a difference between the dead time y of the charging driving circuit in the no-load status and the product; and
calculating a product of the difference and a second coefficient, as the dead time y of the charging driving circuit in the loaded status.

5. The dead time determination method according to claim 1, wherein determining the load status of the charging driving circuit according to the output current of the charging driving circuit comprises:
if the output current of the charging driving circuit is greater than a first preset threshold, determining the load status of the charging driving circuit as a loaded status; and
if the output current of the charging driving circuit is less than a second preset threshold, determining the load status of the charging driving circuit as a no-load status.

6. The dead time determination method according to claim 5, wherein the first preset threshold is greater than the second preset threshold.

7. A charging driving circuit, comprising: a power source module, a voltage collection module, a current collection module, a transistor driving circuit, a transistor switching circuit and a micro-control unit;
wherein the power source module is connected to a power source device and configured to provide a power supply voltage;
the transistor switching circuit is connected to a load device and configured to supply power to the load device;
the transistor driving circuit is connected between the micro-control unit and the transistor switching circuit, and configured to drive the transistor switching circuit to be turned on or off;
the voltage collection module is connected to an output end of the transistor switching circuit and configured to collect an output voltage of the transistor switching circuit;
the current collection module is connected to the output end of the transistor switching circuit and configured to collect output current of the transistor switching circuit;
the micro-control unit is connected to the voltage collection module and the current collection module respectively, wherein the micro-control unit is configured to determine dead time of the charging driving circuit according to the output voltage of the transistor switching circuit and the load status of the charging driving circuit, and generate a control signal that controls the transistor switching circuit to be turned on or off according to the dead time.

8. The charging driving circuit according to claim 7, wherein the transistor driving circuit is implemented by a first drive chip and a second drive chip, each being a dual-channel isolated gate driver with dual input interfaces to drive a half-bridge circuit or a full-bridge circuit.

9. The charging driving circuit according to claim 8, wherein the chip model used for the first drive chip and the second drive chip is UCC21520.

10. The charging driving circuit according to claim 7, wherein the micro-control unit comprises:
an acquisition unit configured to acquire the output voltage and the output current of the charging driving circuit;
a judgement unit configured to judge a load status of the charging driving circuit according to the output current; and
a calculation unit configured to calculate the dead time of the charging driving circuit according to the output voltage and the load status.

11. A charging apparatus, comprising the charging driving circuit according to any one of claim 7.

12. A computer device, comprising a memory, a processor, and a computer program stored in the memory and executable in the processor, wherein when executing the computer program, the processor implements the dead time determination method according to claim 1.

13. (canceled)

14. The charging apparatus according to claim 11, wherein the transistor driving circuit is implemented by a first drive chip and a second drive chip, each being a dual-channel isolated gate driver with dual input interfaces to drive a half-bridge circuit or a full-bridge circuit.

15. The charging apparatus according to claim 14, wherein the chip model used for the first drive chip and the second drive chip is UCC21520.

16. The charging apparatus according to claim 11, wherein the micro-control unit comprises:
an acquisition unit configured to acquire the output voltage and the output current of the charging driving circuit;
a judgement unit configured to judge a load status of the charging driving circuit according to the output current; and
a calculation unit configured to calculate the dead time of the charging driving circuit according to the output voltage and the load status.

17. The computer device according to claim 12, wherein the load status is a no-load status or a loaded status.

18. The computer device according to claim 17, wherein determining the dead time of the charging driving circuit in the no-load status comprises:
calculating a product of a proportional coefficient and an input voltage; and
calculating a sum of the product and a bias constant, as the dead time of the charging driving circuit in the no-load status.

19. The computer device according to claim 18, wherein determining the dead time of the charging driving circuit in the loaded status comprises:
calculating a product of a first coefficient and a ratio of a system clock frequency to a working frequency;
calculating a difference between the dead time of the charging driving circuit in the no-load status and the product; and
calculating a product of the difference and a second coefficient, as the dead time of the charging driving circuit in the loaded status.

20. The computer device according to claim 12, wherein determining the load status of the charging driving circuit according to the output current of the charging driving circuit comprises:
if the output current of the charging driving circuit is greater than a first preset threshold, determining the load status of the charging driving circuit as a loaded status; and
if the output current of the charging driving circuit is less than a second preset threshold, determining the load status of the charging driving circuit as a no-load status.

21. The computer device according to claim 20, wherein the first preset threshold is greater than the second preset threshold.
